(19) United States
(12) Patent Application Publication
(10) Pub. No.: US 2025/0183648 A1
(43) Pub. Date: Jun. 5, 2025

(54) Electronic Fuse and Control Method

(71) Applicant: Halo Microelectronics Co., Ltd., Foshan City (CN)

(72) Inventor: Dongming Liu, Foshan City (CN)

(21) Appl. No.: 18/431,937

(22) Filed: Feb. 3, 2024

(30) Foreign Application Priority Data
Dec. 1, 2023 (CN) 2023116334139

(51) Int. Cl. H02H 3/08; H02H 9/00

(52) U.S. Cl. CPC H02H 3/08; H02H 9/001

(57) ABSTRACT

The electronic fuse includes a first power switch having two non-control terminals. A first non-control terminal of the first power switch is connected to a power input terminal and a second non-control terminal of the first power switch is connected to a power output terminal. The control method for controlling the electronic fuse includes when the power input terminal is connected to an input power source, the power output terminal is connected to a load, and the first power switch is conducting, if it is determined that a connection between the load and the power output terminal is disconnected, controlling the first power switch to turn off, and after controlling the first power switch to turn off, if it is determined that the connection between the load and the power output terminal is established, controlling the first power switch to conduct in a soft start manner through a soft start circuit.

### RELATED APPLICATION

This application claims the benefit of and priority to Chinese Patent Application No. 2023116334139, filed on Dec. 1, 2023, which is hereby incorporated by reference in its entirety.

### TECHNICAL FIELD

This application relates to the technical field of fuses, particularly to a control method and an electronic fuse in the form of a power switch.

### BACKGROUND

Electronic fuse chips are advanced electronic components widely used in various electronic devices and systems, with one of their applications being in servers. The primary function of such chips is to monitor current and disconnect circuits when necessary to protect equipment from being damaged due to overcurrent and overload. In server environments, electronic fuse chips play a crucial role. Due to the substantial data processing and complex applications typically handled by servers, their dependence on a stable power supply is critical. Electronic fuse chips, by continuously monitoring current in real-time, can promptly detect any potential power issues, such as overcurrent or short circuits, and rapidly cut off the relevant circuits to prevent the equipment from being damaged. The fast response time and precise protection mechanism of these chips enable servers to maintain stable operation in the face of power fluctuations or other electrical faults. Additionally, electronic fuse chips often feature programmable characteristics, allowing different configurations based on specific requirements of the server, providing a customized current protection solution. Overall, the application of electronic fuse chips in servers not only enhances the reliability and stability of the equipment, but also provides maintenance and management personnel with improved power management tools, ensuring efficient operation of servers under any circumstances.

However, during the use of electronic fuses, the reinsertion of a load connected to the electronic fuse after being unplugged may result in abnormal operation of the electronic fuse due to the high current generated.

### SUMMARY

The present application aims to provide a method for controlling an electronic fuse and an electronic fuse that can enhance the stability of the operation of the electronic fuse.

To achieve the above objectives, on one aspect, the present application provides a method for controlling an electronic fuse. The electronic fuse comprises a first power switch having two non-control terminals. A first non-control terminal of the first power switch is connected to a power input terminal and a second non-control terminal of the first power switch is connected to a power output terminal. The method comprises when the power input terminal is connected to an input power source, the power output terminal is connected to a load, and the first power switch is conducting, if it is determined that a connection between the load and the power output terminal is disconnected, controlling the first power switch to turn off, and after controlling the first power switch to turn off, if it is determined that the connection between the load and the power output terminal is established, controlling the first power switch to conduct in a soft start manner through a soft start circuit.

In an optional embodiment, the method further comprises after controlling the first power switch to turn off and resetting the soft start circuit in the electronic fuse, if it is determined that the connection between the load and the power output terminal is established, then controlling the first power switch to be turned on in a soft start manner through the soft start circuit.

In an optional embodiment, the method further comprises when the power input terminal is connected to the input power source, the power output terminal is connected to the load, and the first power switch is conducting, if an output current at the power output terminal is less than a first preset current threshold, determining that the connection between the load and the power output terminal is disconnected.

In an optional embodiment, the method further comprises when the power input terminal is connected to the input power source, the power output terminal is connected to the load, and the first power switch is conducting, controlling the first power switch to turn off for a first preset duration, within the first preset duration, if a voltage at the power output terminal has not decreased to a first preset voltage threshold, determining that the connection between the load and the power output terminal is disconnected.

In an optional embodiment, the specific configuration of controlling the first power switch to turn off for a first preset duration includes configuring the first power switch to be connected in the form of a diode, such that the first power switch remains turned off when the voltage difference between the power input terminal and the power output terminal is less than a first voltage difference value and hold for the first preset duration.

In an optional embodiment, after controlling the first power switch to turn off, the method further comprises configuring a first current source in the electronic fuse to output a first current to the power output terminal, in order to maintain a voltage difference between the power input terminal and the power output terminal that is less than a preset voltage difference threshold, and determining that the connection between the load and the power output terminal is established if the voltage at the power output terminal decreases to below a second preset voltage threshold.

In an optional embodiment, the method further comprises resetting the soft start circuit in the electronic fuse when the first power switch is conducting, so that the first power switch is configured to conduct in a soft start manner at a next time.

In an optional embodiment, wherein after controlling the first power switch to turn off, the method further comprises resetting the soft start circuit in the electronic fuse when the first power switch is conducting, so that the first power switch is configured to conduct in a soft start manner at a next time.

The second aspect of the present application provides an electronic fuse comprising a first power switch having non-control terminals. The first non-control terminal of the first power switch is connected to a power input terminal and the second non-control terminal of the first power switch is connected to a power output terminal, and a controller for controlling the conduction and disconnection of the first power switch to perform the aforementioned method.

In an optional embodiment, the electronic fuse further comprises a first comparator. The first comparator is connected to both the power output terminal and the controller. The first comparator is used to output a first comparison signal to the controller based on a comparison result between a voltage at the power output terminal and a preset reference voltage threshold, and wherein the first comparison signal is at a first logic level when the voltage at the power output terminal is greater than the reference voltage threshold, and the first comparison signal is at a second logic level when the voltage at the power output terminal is less than or equal to the reference voltage threshold.

In an optional embodiment, the electronic fuse further comprises a second comparator. The second comparator is used to output a second comparison signal based on a comparison result between an output current at the power output terminal and a first preset current threshold, and wherein, the second comparison signal is at a first logic level when the output current is less than the first preset current threshold, and the second comparison signal is at a second logic level when the output current is greater than or equal to the first preset current threshold. The controller is also connected to the second comparator and is used to receive both the first comparison signal and the second comparison signal. The controller is configured to control the first power switch to turn off when both the first comparison signal and the second comparison signal are at the first logic level

In an optional embodiment, a first input terminal of the first comparator is connected to the power output terminal. A second input terminal of the first comparator receives the reference voltage threshold. An output terminal of the first comparator is connected to the controller. A first input terminal of the second comparator receives a voltage signal or a current signal corresponding to the output current at the power output terminal. A second input terminal of the second comparator receives a voltage signal or a current signal corresponding to the first preset current threshold. An output terminal of the second comparator is connected to the controller.

In an optional embodiment, the electronic fuse further comprises a first current source. The first current source is connected to the power output terminal and is configured to output a current to the power output terminal after the first power switch is turned off.

In an optional embodiment, the first current source comprises a first resistor and a first switch. A circuit formed by a series connection of the first resistor and the first switch is parallel to the first power switch. The first switch is configured to turn on after the first power switch is turned off.

In an optional embodiment, the first current source comprises a second power switch and a second switch. The second power switch is parallel to the first power switch, and the second switch is connected between a control terminal of the second power switch and a control terminal of the first power switch. The second switch is configured to turn off when both the first comparison signal and the second comparison signal are at the first logic level, allowing the second power switch to be individually controlled and maintained by the controller in a conducting state when the first power switch is turned off.

In an optional embodiment, the electronic fuse further comprises a soft start circuit, and the soft start circuit comprises a second current source and a third current source. Both the second current source and the third current source are connected to the controller. Both the second current source and the third current source are connected to an external first capacitor. The second current source is configured to discharge the first capacitor when the soft start circuit is reset. The third current source is configured to, after the soft start circuit is reset, during the process of re-conducting the first power switch, charge the first capacitor, enabling the first power switch to conduct in a soft start manner.

In an optional embodiment, the electronic fuse further comprises a second comparator, a third switch, a second resistor, a third resistor, a first operational amplifier, a third power switch, and a fourth power switch.

A first terminal of the third switch is connected to a first terminal of the first power switch. A second terminal of the third switch is connected to a first terminal of the third power switch. A first terminal of the second resistor and a first terminal of the third resistor are both connected to the power input terminal. A second terminal of the second resistor is connected to both a first input terminal of the first operational amplifier and a third terminal of the third power switch. A second terminal of the third resistor is connected to both a second input terminal of the first operational amplifier and a second terminal of the fourth power switch. An output terminal of the first operational amplifier is connected to a first terminal of the fourth power switch. A third terminal of the fourth power switch is connected to one input terminal of the second comparator. An output terminal of the second comparator is connected to the controller.

The controller is further configured to control the third switch to establish a connection between a gate of the first power switch and a gate of the third power switch when a detected current flowing through the fourth power switch is greater than or equal to a second preset current threshold. The controller is configured to control the third switch to disconnect a connection between the gate of the first power switch and the gate of the third power switch, and configure the first power switch to function as a diode when a detected current is less than a second preset current threshold. The controller is configured to turn off the first power switch when the output current is less than the first preset current threshold.

In an optional embodiment, when the first power switch is conducting, the controller configures the first power switch to function as a diode for a first preset duration, and wherein within the first preset duration, if a voltage at the power output terminal has not decreased to a first preset voltage threshold, the controller controls the first power switch to turn off.

In an optional embodiment, the electronic fuse further comprises a second comparator. The second comparator is used to output a second comparison signal based on a comparison result between an output current at the power output terminal and a first preset current threshold. When the first power switch is conducting, if the output current at the power output terminal is less than the first preset current threshold, the controller controls the first power switch to function as a diode for the first preset duration. Within the first preset duration, if a voltage at the power output terminal has not decreased to the first preset voltage threshold, the controller determines that the connection between the load and the power output terminal is disconnected.

In an optional embodiment, the electronic fuse further comprises a pre-turn-off switch. The pre-turn-off switch is connected between a gate and a drain of the first power switch, and the pre-turn-off switch is connected to the controller. The controller is further configured to control the pre-turn-off switch to establish a connection between the gate and the drain of the first power switch, thereby configuring the first power switch to function as a diode.

In an optional embodiment, when the first power switch is turned off and the voltage at the power output terminal decreases to less than or equal to a second preset voltage threshold, the controller controls the first power switch to be turned on in a soft start manner.

The advantageous effects of the present application are as follows: the control method for the electronic fuse provided in this application comprises connecting the power input terminal to the input power source and connecting the power output terminal to the load. When the first power switch is turned on, if it is determined that the connection between the load and the power output terminal is disconnected, the control circuit turns off the first power switch. Subsequently, when the load connected to the electronic fuse is unplugged and plugged in again, it is necessary to control the first power switch to turn on in a soft-start manner through a soft-start circuit. This ensures that the current increases slowly, preventing the occurrence of a sudden large current. This is beneficial for reducing the risk of abnormal operation of the electronic fuse and, consequently, enhances the stability of the electronic fuse operation.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

One or more embodiments are illustratively described with corresponding images in the accompanying drawings. These illustrative descriptions do not constitute limitations on the embodiments. Elements in the drawings with the same reference numerals represent similar elements, unless otherwise expressly stated. The images in the drawings are not to scale unless specifically indicated.

FIG. 1 is a schematic diagram of an electronic fuse provided in the first embodiment of the present application;

FIG. 2 is a schematic diagram of an electronic fuse provided in the second embodiment of the present application;

FIG. 3 is a schematic diagram of various signals in the electronic fuse shown in FIG. 2;

FIG. 4 is a schematic diagram of an electronic fuse provided in the third embodiment of the present application;

FIG. 5 is a schematic diagram of an electronic fuse provided in the fourth embodiment of the present application;

FIG. 5A is a schematic diagram of an electronic fuse provided in the fifth embodiment of the present application;

FIG. 6 is a schematic diagram of an electronic fuse provided in the sixth embodiment of the present application;

FIG. 6A is a schematic diagram of an electronic fuse provided in the seventh embodiment of the present application;

FIG. 7 is a flowchart of the control method of the electronic fuse provided in the first embodiment of the present application;

FIG. 8 is a first way to determine the disconnection of the connection between the load and the power output terminal provided in the first embodiment of the present application;

FIG. 9 is a second way to determine the disconnection of the connection between the load and the power output terminal provided in the first embodiment of the present application;

FIG. 9A is a schematic diagram of an electronic fuse provided in the eighth embodiment of the present application;

FIG. 10 is a third way to determine the disconnection of the connection between the load and the power output terminal provided in the first embodiment of the present application;

FIG. 10A is a schematic diagram of an electronic fuse provided in the ninth embodiment of the present application; and

FIG. 11 is a way to determine the establishment of the connection between the load and the power output terminal provided in the first embodiment of the present application.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

To make the objectives, technical solutions, and advantages of the embodiments of the present application clearer, the embodiments will be described in detail with reference to the accompanying drawings. Obviously, the described embodiments are only part of the embodiments of the present application, not all embodiments. Based on the embodiments in the present application, all other embodiments obtained by those skilled in the art without creative work are within the scope of protection of the present application.

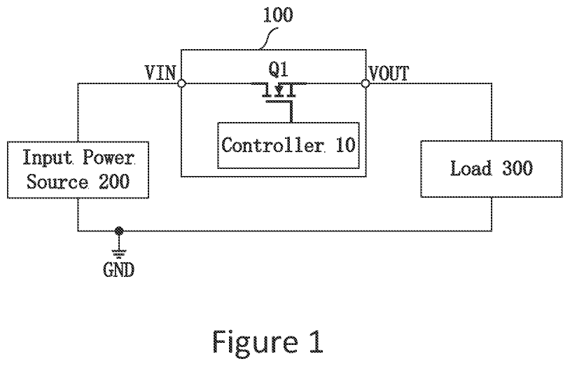

Please refer to FIG. 1. FIG. 1 is a schematic diagram illustrating the structure of an electronic fuse provided in an embodiment of the present application. As shown in FIG. 1, the electronic fuse 100 comprises a first power switch Q1 and a controller 10.

In this embodiment, the first power switch Q1 is used to establish or disconnect the connection between the input power source 200 and the load 300. The controller 10 is responsible for controlling the turn on and turn off of the first power switch Q1 to execute the control method of the electronic fuse in any embodiment of the present application. Specifically, when the controller 10 controls the first power switch Q1 to turn on, the connection between the input power source 200 and the load 300 is established. When the controller 10 controls the first power switch Q1 to turn off, the connection between the input power source 200 and the load 300 is disconnected.

In this embodiment, for example, the first power switch Q1 is implemented as an NMOS transistor. The control terminal of the first power switch Q1 is the gate of the NMOS transistor. A first non-control terminals of the first power switch Q1 is the drain of the NMOS transistor, and a second non-control terminals of the first power switch Q1 is the source of the NMOS transistor. In other words, the non-control terminals of the first power switch Q1 include two terminals, namely, the source and drain of the NMOS transistor. The gate of the first power switch Q1 is connected to the controller 10. The source is connected to the power output terminal VOUT, and the drain is connected to the power input terminal VIN.

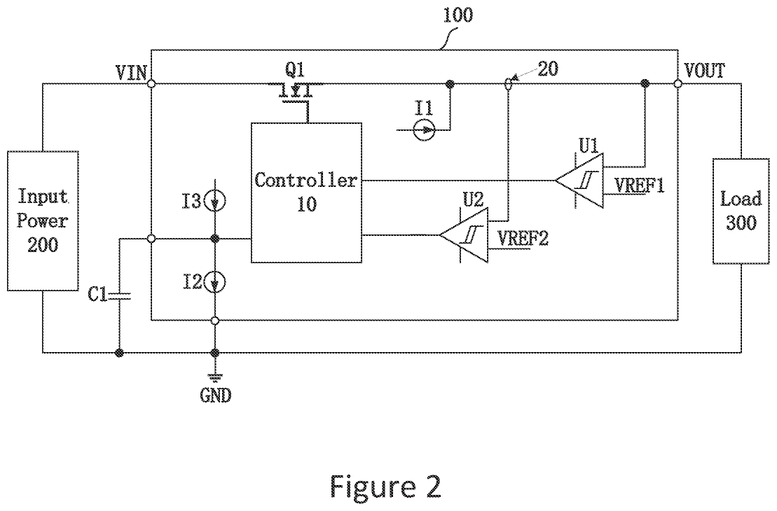

In one embodiment, as shown in FIG. 2, the electronic fuse 100 further comprises a first comparator U1. The first comparator U1 is connected to both the power output terminal VOUT and the controller 10. The first comparator U1 is used to compare the voltage at the power output terminal VOUT with a preset reference voltage threshold VREF1, and output the first comparison signal to the controller 10 based on this comparison. Specifically, when the voltage at the power output terminal VOUT is greater than the reference voltage threshold VREF1, the first comparison signal is at the first logic level. When the voltage at the power output terminal VOUT is less than or equal to the reference voltage threshold VREF1, the first comparison signal is at the second logic level. The reference voltage threshold VREF1 can be set according to the specific application, and this embodiment does not impose specific limitations on it.

Specifically, the first input of the first comparator U1 is connected to the power output terminal VOUT. The second input of the first comparator U1 receives the reference voltage threshold VREF1. The output of the first comparator U1 is connected to the controller 10. In this embodiment, the first input of the first comparator U1 is used as the non-inverting input, and the second input is used as the inverting input.

The first logic level and the second logic level are different levels. Specifically, when the first logic level is high level, the second logic level is low level, and when the first logic level is a low level, the second logic level is a high level. For the sake of clarity in this embodiment of the present application, the description is provided with the assumption that the first logic level is a high level, and the second logic level is a low level. The first comparator U1 can also be a comparator with hysteresis to reduce the impact of noise signals on the comparator output.

Specifically, the first comparator U1 is used to detect whether the output voltage VOUT is normal, and outputs the first comparison signal representing whether the output voltage VOUT is normal. When the output voltage VOUT is greater than the reference voltage threshold VREF1, the output voltage VOUT is normal. This corresponds to the input power source 200 supplying power to the load 300 normally through the conducting first power switch Q1, or the load 300 has been unplugged (i.e., the connection between the load 300 and the power output terminal VOUT is disconnected) and has not been plugged in again (i.e., the re-connection between the load 300 and the power output terminal VOUT). When the output voltage VOUT is less than or equal to the reference voltage threshold VREF1, the output voltage VOUT is abnormal. This corresponds to the first power switch Q1 being turned off, causing the load 300 to be powered off, or the load 300 has been unplugged and then plugged in again. In other words, if the first comparison signal received by the controller 10 during the time after the load 300 is unplugged is a high level, the controller 10 determines that the load 300 has not been plugged in again after being unplugged. If the first comparison signal received by the controller 10 during the time after the load 300 is unplugged is a low level, the controller 10 determines that the load 300 has been plugged in again after being unplugged. In some embodiments, the load 300 is an active load. The active load may include a large input capacitor. This causes the voltage at the power output terminal VOUT to drop below the reference voltage threshold VREF1 when it is reinserted into the power output terminal VOUT of the electronic fuse 100, triggering the first comparison signal to transition to a low level.

In some embodiments, different voltage thresholds can be configured through the hysteresis characteristic of the first comparator U1 to detect the normal voltage at the power output terminal VOUT and the reinsertion of the load. For example, it can be configured so that when the voltage at the power output terminal VOUT increases to a level greater than the reference voltage threshold, the first comparator U1 outputs a high level. Conversely, when the voltage at the power output terminal VOUT decreases to a level less than the second preset voltage threshold, the output of the first comparator U1 transitions to a low level.

In another embodiment, the electronic fuse 100 further comprises a second comparator U2. In this embodiment, the second comparator U2 is used to output a second comparison signal based on the comparison result between the output current of the power output terminal VOUT and the first preset current threshold. Specifically, when the output current is less than the first preset current threshold, the second comparison signal is at the first logic level. When the output current is greater than or equal to the first preset current threshold, the second comparison signal is at the second logic level. The first preset current threshold can be set according to the actual application, and this embodiment does not provide specific limitations on it.

Specifically, the first input terminal of the second comparator U2 is coupled to the power output terminal VOUT through a current detection circuit 20. The current detection circuit 20 is used to detect the current flowing out of the power output terminal VOUT and generate a current signal or a voltage signal representing the magnitude of the output current of the power output terminal VOUT to the first input terminal of the second comparator U2. The second input terminal of the second comparator U2 receives a current signal or a voltage signal corresponding to the first preset current threshold. This signal is illustrated here as the voltage signal VREF2. The output terminal of the second comparator U2 is connected to the controller 10. In this embodiment, the first input terminal of the second comparator U2 is the inverting input terminal, and the second input terminal is the non-inverting input terminal. The second comparator U2 can also be a comparator with hysteresis to reduce the impact of noise signals on the comparator output.

In this embodiment, the controller 10 is also connected to the second comparator U2. The controller 10 receives the first comparison signal and the second comparison signal, and controls the first power switch Q1 to turn off when both the first and second comparison signals are at the first logic level.

The second comparator U2 is used to detect whether the load 300 is open-circuited (when the load 300 is open-circuited, the connection between the load 300 and the power output terminal VOUT is disconnected). Specifically, when the output current is less than the first preset current threshold (the current or the voltage signal corresponding to the output current is less than the current or voltage signal VREF2), an open circuit in the load 300 is detected, and the second comparison signal is set to a high logic level. It can be seen that when the first power switch Q1 is conducting and the first comparison signal is at a high logic level, it indicates that the output voltage VOUT is normal. If the second comparison signal transitions to a high logic level, it can be determined that the load 300 is open-circuited. In this case, the controller 10 outputs a low level to the gate of the first power switch Q1, controlling the first power switch Q1 to turn off.

In another embodiment, when the first power switch Q1 is conducting and the first comparison signal is at a high logic level, it indicates that the output voltage VOUT is normal. If the second comparison signal is at a low logic level, it means that the load 300 is not open-circuited. The controller 10 maintains the output to the gate of the first power switch Q1 at a high logic level, thereby keeping the first power switch Q1 in the conducting state.

In one embodiment, the electronic fuse 100 further comprises a first current source I1. The first current source I1 is connected to the power output terminal VOUT, and the first current source I1 is configured to output current to the power output terminal VOUT when the first power switch Q1 is turned off.

Specifically, the first current source I1 is a current source capable of outputting a small current, designed to provide a small current to the load 300 during the time when the first power switch Q1 is turned off, maintaining the voltage at the power output terminal VOUT. The primary purpose of maintaining the voltage at the power output terminal VOUT is to prevent a decrease of the voltage due to leakage current at the power output terminal VOUT after the first power switch Q1 is turned off, which could trigger the transition of the first comparison signal from a high level to a low level. The output current of the first current source I1 needs to be significantly smaller than the current pulled by the load when the load 300 is inserted. This ensures that the insertion of the load 300 can successfully pull down the voltage at the power output terminal VOUT, triggering the high-to-low transition of the first comparison signal. The first current source I1 can be controlled by the first and second comparison signals. Specifically, when the first comparison signal is at a high level and the second comparison signal is at a high level, the first power switch Q1 is turned off, and the first current source I1 is configured to output a small current to the power output terminal VOUT.

In one embodiment, the electronic fuse 100 further comprises a soft start circuit, and the soft start circuit comprises a second current source I2 and a third current source I3. Specifically, both the second current source I2 and the third current source I3 are connected to the controller 10. Additionally, both the second current source I2 and the third current source I3 are also connected to an external first capacitor C1.

Specifically, the second current source I2 is configured to drive the first capacitor C1 to discharge when the soft start circuit is reset. Subsequently, the third current source I3 is configured to charge the first capacitor C1 during the process of turning on the first power switch Q1 after it is turned off, allowing the first power switch Q1 to conduct in a soft-start manner.

In this embodiment, the second current source I2 can be controlled by the first comparison signal. When the first comparison signal is at a high level and after an optional delay time, the second current source I2 is enabled to discharge the first capacitor C1, achieving the purpose of resetting the soft start circuit. This enables that, at the next time, the first power switch Q1 is turned on in a soft-start manner. During the next turn on process of the first power switch Q1, the third current source I3 is configured to charge the first capacitor C1. Consequently, the voltage applied to the gate of the first power switch Q1 gradually increases with the increase of voltage across the first capacitor C1, allowing the first power switch Q1 to slowly turn on. This achieves a soft-start process for the first power switch Q1, preventing the generation of an instantaneous large current through the first power switch Q1. In this embodiment, the reset of the soft start circuit is triggered directly by the first comparison signal being at a high level after an optional delay time, ensuring that the soft-start process can be implemented when the load 300 is reinserted after the first power switch Q1 is turned off.

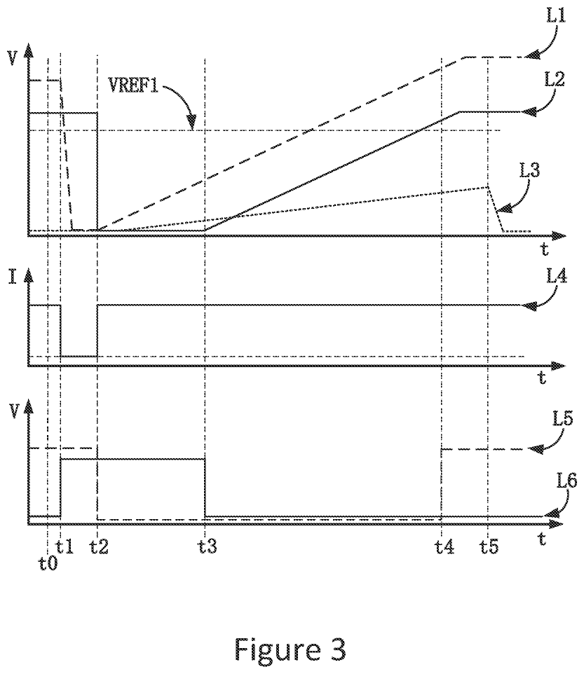

Please refer to FIG. 3. FIG. 3 illustrates the signals in the electronic fuse shown in FIG. 2 during the process of the load 300 being pulled out and then reinserted. As shown in FIG. 3, the horizontal axis represents time, and the vertical axes represent voltage (V), current (I), and voltage (V) respectively. Curve L1 represents the voltage at the gate of the first power switch Q1. Curve L2 represents the voltage at the power output terminal VOUT. Curve L3 represents the voltage on the first capacitor C1. Curve L4 represents the output current IOUT at the power output terminal VOUT. Curve L5 represents the first comparison signal. Curve L6 represents the second comparison signal.

Specifically, at time t0, the electronic fuse has completed a normal power-up, and the output current at the power output terminal VOUT is greater than the first preset current threshold. At this moment, the first capacitor C1 has been discharged, indicating that the reset of the soft start circuit has been completed.

At time t1, the load 300 is disconnected, causing an instantaneous decrease in the output current IOUT, and the second comparison signal switches from a low level to a high level. Subsequently, in response to both the first and second comparison signals being high level, the voltage at the gate of the first power switch Q1 is pulled low, gradually turning off the first power switch Q1. Meanwhile, the first current source I1 is activated to output a first current to the power output terminal VOUT. Therefore, during the time period from t1 to t2, the voltage at the power output terminal VOUT remains high, i.e., the first comparison signal remains at a high level.

At time t2, the load 300 is reconnected. The surge current caused by the insertion of the load 300 leads to a rapid increase in the output current IOUT, significantly exceeding the first current output by the first current source I1. As a result, the voltage at the power output terminal VOUT quickly drops below the reference voltage threshold VREF1, triggering the first comparison signal to switch from a high level to a low level. When the first comparison signal is at a low level, indicating the detection of the load 300 being reconnected, the first current source I1 stops outputting the first current, and the third current source I3 is activated to charge the first capacitor C1. Subsequently, the voltage at the gate of the first power switch Q1 follows the voltage on the first capacitor C1, gradually rising to achieve the soft-start process of the first power switch Q1. It can be observed that the slow rise of the voltage at the gate of the first power switch Q1 effectively limits the load current IOUT, preventing the generation of surge current and thereby avoiding triggering the fast overcurrent protection mechanism of the electronic fuse.

At time t3, the first power switch Q1 is fully turned on, and the output current IOUT is greater than the first preset current threshold, causing the second comparison signal to switch to a low level.

At time t4, the voltage at the power output terminal VOUT is higher than the reference voltage threshold VREF1, causing the first comparison signal to switch from a low level to a high level.

After an optional preset delay duration, at time t5, the operation of the second current source I2 is controlled to drive the discharge of the first capacitor C1, achieving the reset of the soft start circuit.

It should be noted that by selecting the first comparator U1 with a hysteresis function, it is possible to achieve the triggering of load 300 reinsertion (i.e., when the voltage at the power output terminal VOUT decreases to a level below the second preset voltage threshold) and the reset of the soft start circuit (i.e., when the voltage at the power output terminal VOUT increases to a level above the reference voltage threshold) at two different voltage levels of the power output terminal VOUT.

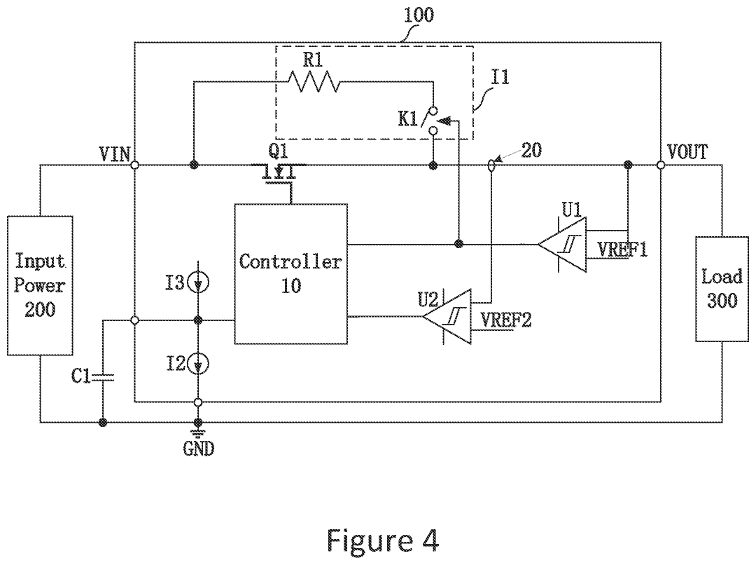

Please refer to FIG. 4. FIG. 4 schematically illustrates one implementation of the first current source I1. As shown in FIG. 4, the first current source I1 includes the first resistor R1 and the first switch K1. The circuit formed by the first resistor R1 and the first switch K1 connected in series, and then connected in parallel with the first power switch Q1.

Specifically, the first switch K1 is controlled by the controller 10. In some embodiments, the first switch K1 is configured to turn on when both the first comparison signal and the second comparison signal are at the first logic level. When the first switch K1 is turned on, the voltage between the power input terminal VIN and the power output terminal VOUT acts on the first resistor R1 to generate the first current. The first resistor R1 is typically chosen with a relatively large resistance value to ensure that the current flowing through the first resistor R1 is sufficient to offset the leakage current at the power output terminal VOUT after the load 300 is disconnected, thereby maintaining a voltage close to the power input terminal VIN on the power output terminal VOUT. In some embodiments, the processing of the first comparison signal and the second comparison signal can be implemented externally to the controller 10 through logic gate circuits (such as NAND gates). In other embodiments, the first switch K1 can also be incorporated into the controller 10 using logic gate circuits. For these variations in implementation, they are modifications understandable to those skilled in the art from FIG. 4 and are not further elaborated herein.

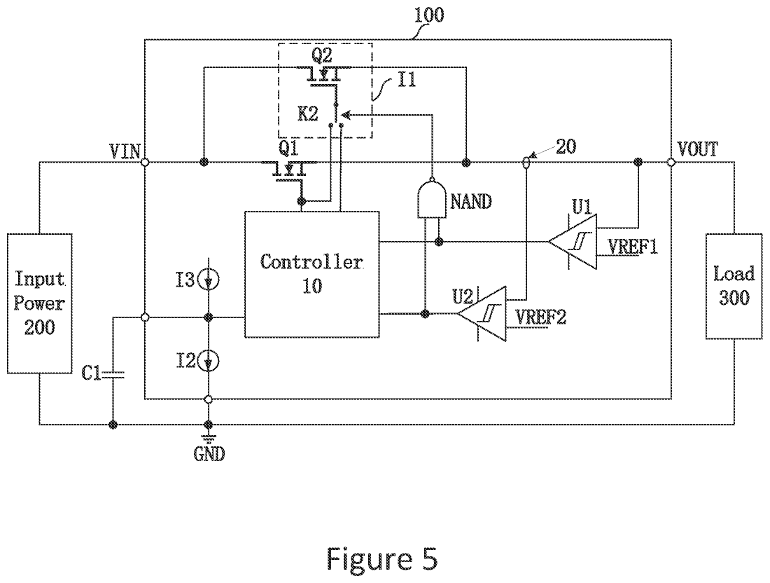

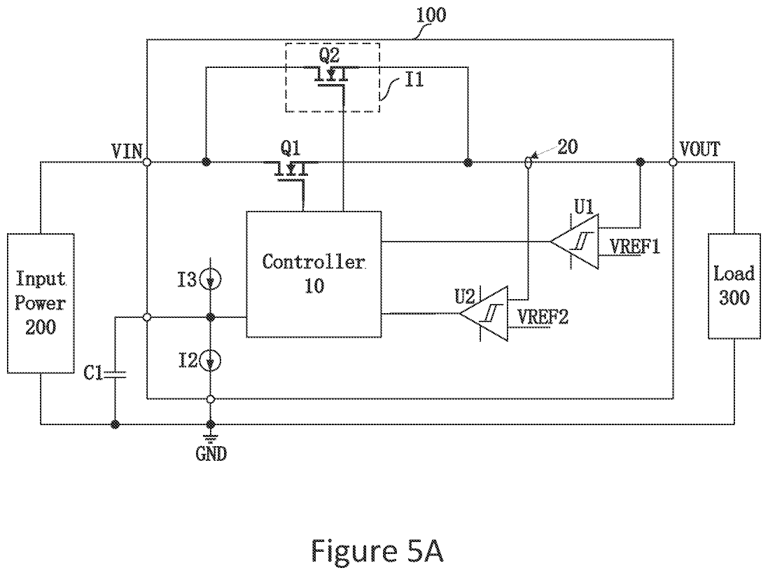

Please refer to FIG. 5, which exemplifies another implementation of the first current source I1. As shown in FIG. 5, the first current source I1 comprises the second power switch Q2 and the second switch K2. In some embodiments, the second power switch Q2 is formed by a portion of the first power switch Q1.

In this arrangement, the second power switch Q2 is connected in parallel with the first power switch Q1. The second switch K2 is used to configure the connection mode of the control terminal of the second power switch Q2. In one mode, the control terminals of the first power switch Q1 and the second power switch Q2 are connected, so that both power switches are driven by the same control signal. In another mode, the connection between the control terminals of the two power switches is disconnected. When the first power switch Q1 is turned off, the control terminal of the second power switch Q2 is directly driven by the controller 10.

Specifically, the second switch K2 is configured to disconnect the connection between the gate of the first power switch Q1 and the gate of the second power switch Q2 when both the first comparison signal and the second comparison signal are at the high level. The gate of the second power switch Q2 is then directly controlled by the controller 10. In this implementation, the control of the second switch K2 is determined by the first and second comparison signals, through a NAND gate. The inputs of the NAND gate receive the first and second comparison signals respectively, and the output of the NAND gate is used to control the second switch K2. When both the first and second comparison signals are at a high level, the NAND gate outputs a low level to the second switch K2, causing it to disconnect the gates of the first power switch Q1 and the second power switch Q2, and configuring the gate of the second power switch Q2 to be directly controlled by the controller 10.

Specifically, assuming that the structures of the first power switch Q1 and the second power switch Q2 are similar and their width-to-length ratios have a ratio of K:1, when both power switches are conducting, the ratio of the current flowing through the first power switch Q1 (IQ1) to the current flowing through the second power switch Q2 (IQ2) is K:1, i.e., IQ1:IQ2=K:1. When the current flowing through the power output terminal OUT is very small, the second comparator U2 outputs the second comparison signal to a high level, determining that the connection between the load 300 and the power output terminal VOUT has been disconnected. Since during normal operation, the first comparison signal is also at a high level, in response to the change in the second comparison signal, the second switch K2 disconnects the connection between the gate of the first power switch Q1 and the gate of the second power switch Q2 and configures the gate of the second power switch Q2 to be independently controlled by the controller 10. Subsequently, the voltage at the gate of the first power switch Q1 is pulled low, turning off the first power switch Q1. Meanwhile, the power switch Q2 is independently controlled by the controller 10, maintaining a high level to supply current to the power output terminal VOUT. Thus, in this embodiment, by setting the control of the second switch K2 to disconnect the gates of the first power switch Q1 and the second power switch Q2 when both the first and second comparison signals are at a high level, the gate voltages of the two power switches can be made different, allowing separate control of the first power switch Q1 and the second power switch Q2. Consequently, it is possible to control the second power switch Q2 to maintain a suitable equivalent resistance and conduct a very small current (i.e., the first current) to the power output terminal VOUT when controlling the first power switch Q1 to turn off.

It should be noted that the NAND gate circuit and the switch K2 in FIG. 5 can be integrated into the controller 10 (as shown in FIG. 5A) and implemented by other logic circuits and switch circuits. Further details are not elaborated herein.

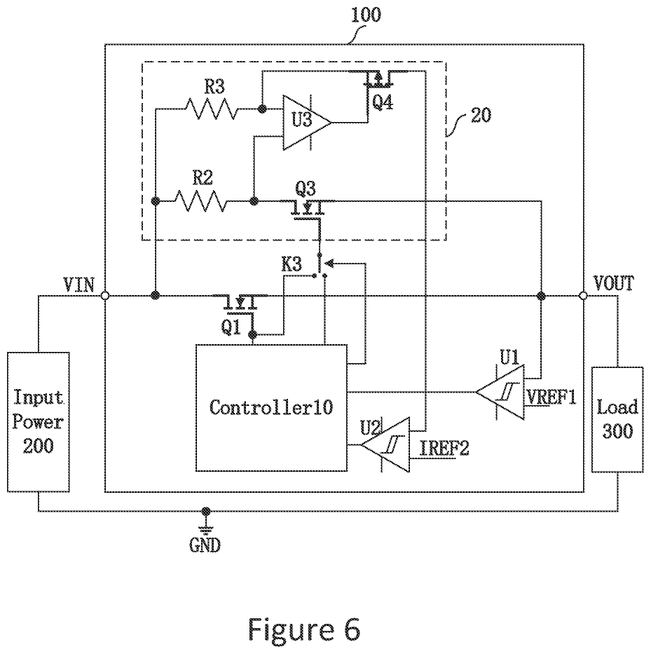

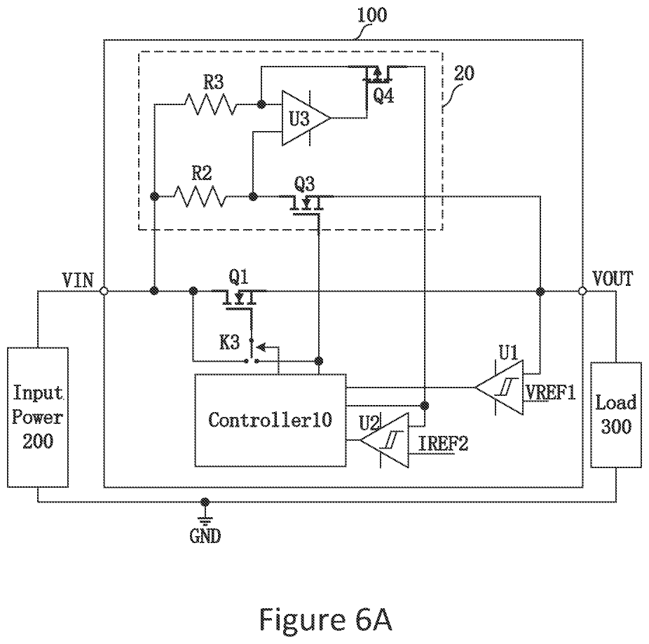

Please refer to FIG. 6. FIG. 6 exemplarily illustrates a structure of the current detection circuit 20 and another embodiment of the first current source I1 in the electronic fuse 100. As shown in FIG. 6, the current detection circuit 20 in the electronic fuse 100 comprises a third switch K3, a second resistor R2, a third resistor R3, a first operational amplifier (i.e., the first op-amp) U3, a third power switch Q3, and a fourth power switch Q4.

The first terminal of the third switch K3 is connected to the first terminal of the first power switch Q1. The second terminal of the third switch K3 is connected between the first terminal of the third power switch Q3. The first terminal of the second resistor R2 and the first terminal of the third resistor R3 are both connected to the power input terminal VIN. The second terminal of the second resistor R2 is connected to the first input terminal of the first operational amplifier U3 and the third terminal of the third power switch Q3. The second terminal of the third resistor R3 is connected to the second input terminal of the first operational amplifier U3 and the second terminal of the fourth power switch Q4. The second terminal of the third power switch Q3 is connected to the power output terminal VOUT. The output terminal of the first operational amplifier U3 is connected to the first terminal of the fourth power switch Q4. The first input terminal of the second comparator U2 is connected to the third terminals of the fourth power switch Q4, either directly or through a connection to the controller 10 (as illustrated in FIG. 6A, where the first input terminal of the second comparator U2 is connected to the third terminal of the fourth power switch Q4). Additionally, the third switch K3 is also connected to the controller 10.

Specifically, in some embodiments, the controller 10 is also used to acquire the detection current flowing through the fourth power switch Q4 (referred to as the detection current), and based on the detection current, determine the output current of the power output terminal VOUT. In other embodiments, the second comparator U2 can be used to detect the detection current output by the current detection circuit 20 (the current flowing through the fourth power switch Q4) and inform the controller 10 of the relationship between the detection current and the second preset current threshold through the second comparison signal output by the second comparator U2. The controller 10 is also used to control the third switch K3 to connect the first terminal of the first power switch Q1 and the first terminal of the third power switch Q3 when the detection current is greater than or equal to the second preset current threshold. When the detection current is less than the second preset current threshold, the controller 10 controls the third switch K3 to disconnect the first terminal of the first power switch Q1 and the first terminal of the third power switch Q3. The second preset current threshold can be set based on the actual application, and this embodiment does not impose specific limitations on it.

In this embodiment, when the detection current is greater than or equal to the second preset current threshold, the corresponding current flowing through the first power switch Q1 is relatively large. At this point, the controller 10 controls the third switch K3 to connect the first terminal of the first power switch Q1 and the first terminal of the third power switch Q3, so that the first power switch Q1 and the third power switch Q3 share the source and gate. If the ratio of the width-to-length ratios of the first power switch Q1 and the third power switch Q3 is denoted as M, the current flowing through the third power switch Q3 is equal to 1/M times the output current IOUT of the power output terminal VOUT. At the same time, the feedback loop formed by the first operational amplifier U3, the second resistor R2, the third resistor R3, and the fourth power switch Q4 can keep the voltages at the two input terminals of the first operational amplifier U3 equal. Then, the detection current flowing through the fourth power switch Q4 can be expressed as IOUT/M×R2/R3. IOUT is the output current at the power output terminal VOUT. In some embodiments, the detection current is fed into the controller 10, allowing the controller 10 to determine the amplitude of the output current IOUT based on the detection current. In other embodiments, the detection current can be fed into the second comparator U2, and the relationship between the detection current and the second preset current threshold (such as IREF2) can be conveyed to the controller 10 through the second comparison signal output by the second comparator U2. When the controller 10 detects that the detection current is less than the second preset current threshold, it is determined that the original current detection circuit cannot accurately detect the amplitude of the output current IOUT. Therefore, the controller 10 controls the third switch K3 to disconnect the first terminal of the first power switch Q1 and the first terminal of the third power switch Q3, reconstructing the current detection circuit to achieve higher current detection accuracy. At this point, the controller 10 can independently configure the first power switch Q1 to be in a pre-turn-off state, and independently control the third power switch Q3 to remain on. In some embodiments, the pre-turn-off state of the first power switch Q1 can be achieved by shorting the gate and drain of the first power switch Q1, i.e., connecting the first power switch Q1 in the form of a diode. Such a connection can be equivalent to turning off the first power switch Q1 within a finite drain-source voltage difference (i.e., the first voltage difference). Then, all the current between the power input terminal VIN and the power output terminal VOUT flows through the second resistor R2 and the third power switch Q3. At this point, the detection current flowing through the fourth power switch Q4 can be expressed as IOUT×R2/R3. It can be seen that the output current IOUT is effectively amplified by a factor of M. In other words, the current measurement range is changed, enabling more accurate detection of the output current IOUT. Later, when the detection current flowing through the fourth power switch Q4 is less than a preset current threshold (corresponding to the output current IOUT being less than the first preset current threshold), it is determined that the connection between the load 300 and the power output terminal VOUT is disconnected, and the first power switch Q1 is then turned off.

Compared to directly turning off the first power switch Q1, the advantage of configuring the first power switch Q1 in a pre-turn-off state is that it can avoid the issue of the load power disruption caused by sudden changes in load current. When the first power switch Q1 is in the off state and the load current flows entirely through the second resistor R2 and the third power switch Q3, if the load current IOUT suddenly increases, the voltage at the power output terminal VOUT inevitably drops, causing the load 300 to fail to operate normally. However, if the first power switch Q1 is in a pre-turn-off state (i.e. connected as a diode) at this time, as the voltage drop on the second resistor R2 and the third power switch Q3 increases, the drain-source voltage difference of the first power switch Q1 in the pre-turn-off state also increases. Eventually, this voltage difference is sufficient to turn on the first power switch Q1 and provide current to the output. In this way, the minimum voltage at the power output terminal VOUT is the voltage at the power input terminal VIN minus the forward voltage drop of a diode of the first power switch Q1. This effectively prevents the occurrence of the load power disruption due to possible load current spikes during the precise detection of the load current IOUT.

In this embodiment, the determination of whether the detection current is less than the second preset current threshold and whether the output current is less than the first preset current threshold can both be implemented using the second comparator U2. In other embodiments, as shown in FIG. 6A, the determination of whether the detection current is less than the second preset threshold current and whether the output current is less than the first preset current threshold can be implemented separately through the logic circuit inside the controller 10 and the second comparator U2. The specific implementation details are not reiterated herein.

In addition, after determining that the connection between the load 300 and the power output terminal VOUT has been disconnected, the third power switch Q3 can be configured to turn on, and its gate voltage can be controlled to regulate the current flowing through the third power switch Q3. This helps maintain the voltage at the power output terminal VOUT without dropping due to leakage current, thereby preventing the first comparator U1 from switching its first comparison signal from a high level to a low level. In other words, the third power switch Q3 is configured as a part of the reconfigurable current detection circuit 20 when the load 300 is connected to the power output terminal VOUT, and when the load 300 is disconnected from the power output terminal VOUT, the third power switch Q3 can be configured as the first current source I1.

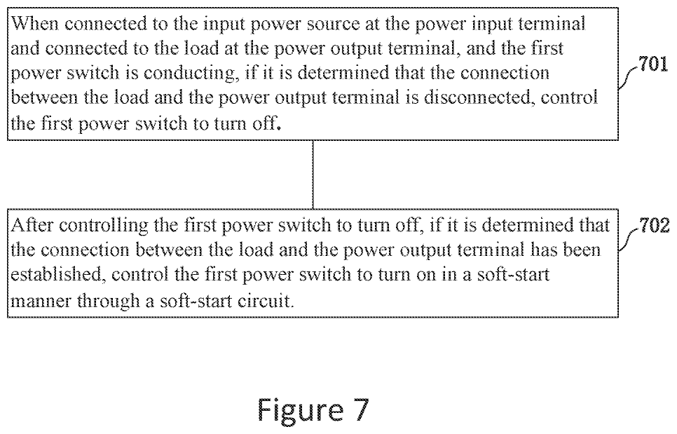

Please refer to FIG. 7. FIG. 7 is a flowchart illustrating the control method of the electronic fuse provided in the present application embodiment. The electronic fuse comprises a first power switch, with two non-control terminals, the first non-control terminal of the first power switch is connected to the power input terminal, and the second non-control terminal of the first power switch is connected to the power output terminal. In some embodiments, the specific structure of the electronic fuse can be referred to as described in FIGS. 1, 2, and 3 to 6, and will not be repeated herein.

As shown in FIG. 7, the control method of the electronic fuse includes the following steps:
Step 701: when connected to the input power source at the power input terminal and connected to the load at the power output terminal, and the first power switch is conducting, if it is determined that the connection between the load and the power output terminal is disconnected, control the first power switch to turn off.
Step 702: after controlling the first power switch to turn off, if it is determined that the connection between the load and the power output terminal has been established, control the first power switch to turn on in a soft-start manner through a soft-start circuit.

If the system connected to the electronic fuse is operating normally, and the first power switch in the electronic fuse is fully turned on, the load is also operating at full power. Removing the load (i.e., disconnecting the load from the power output terminal) and then reconnecting is referred to as hot-plugging the load. In mainstream electronic fuse applications, when the load is disconnected, the electronic fuse does not turn off the first power switch. When the load is reconnected, because the first power switch remains fully turned on, the insertion of capacitors in the connected load can lead to the formation of an AC short circuit. Consequently, at the moment of load insertion, a significant surge current occurs, triggering rapid overcurrent protection. Due to the conservative control strategy often adopted in high-current applications, i.e., after triggering rapid overcurrent protection, the electronic fuse locks the first power switch to keep it turned off. This results in the inability of the hot-plugged load to operate normally. At the same time, the surge current may cause sparking at the leads or fingers of the connection point, posing a potential threat to the safety of the operator.

In the embodiment of the present application, when the load connected to the electronic fuse is removed and then reinserted, the first power switch has already been turned off by the system upon detecting the load removal. Restarting the first power switch can be done in a soft-start manner, ensuring that the current gradually increases without generating a large surge current instantly. This is advantageous in reducing the risk of the electronic fuse experiencing abnormal operation, thereby enhancing the stability of the operation of the electronic fuse and allowing the hot-plugged load to function normally.

After completing step 701, if the load is reconnected to the power output terminal, the first power switch should be slowly turned on in a soft-start manner to prevent the sudden generation of a large current.

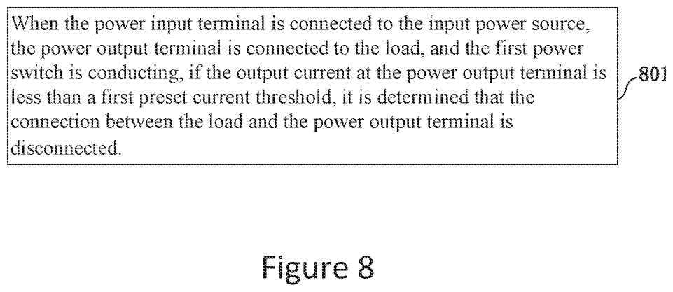

Please refer to FIG. 8, which exemplifies the first method of determining the disconnection of the connection between the load and the power output terminal in the control method of the electronic fuse. As shown in FIG. 8, the control method of the electronic fuse also includes the following method steps:
Step 801: when the power input terminal is connected to the input power source, the power output terminal is connected to the load, and the first power switch is conducting, if the output current at the power output terminal is less than a first preset current threshold, it is determined that the connection between the load and the power output terminal is disconnected.

Specifically, when the first power switch is conducting, continuously monitor the output current, when the output current is less than the first preset current threshold, it is determined that the load is open circuit (i.e., the connection between the load and the power output terminal is disconnected).

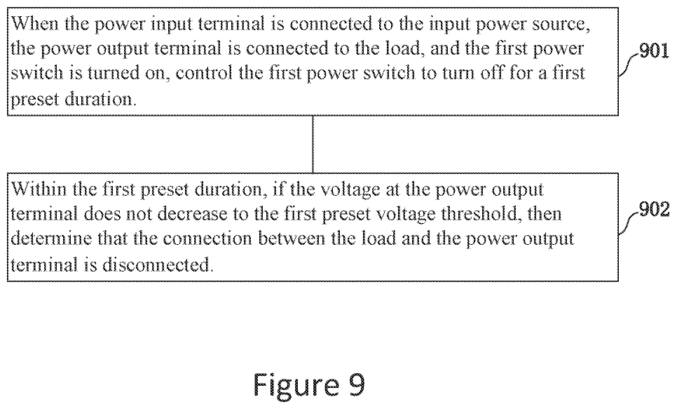

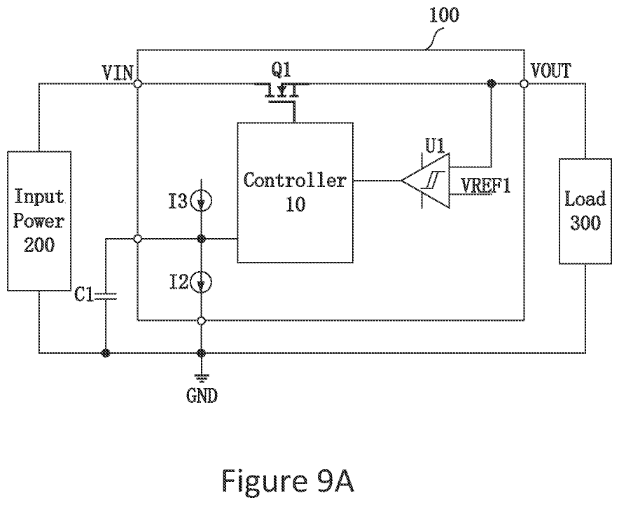

Please refer to FIG. 9. FIG. 9 illustrates a second method for determining the disconnection of the connection between the load and the power output terminal in the control method of the electronic fuse. As shown in FIG. 9, the control method of the electronic fuse further comprises the following method steps:
Step 901: when the power input terminal is connected to the input power source, the power output terminal is connected to the load, and the first power switch is turned on, control the first power switch to turn off for a first preset duration.
Step 902: within the first preset duration, if the voltage at the power output terminal does not decrease to the first preset voltage threshold, then determine that the connection between the load and the power output terminal is disconnected.

The first preset duration can be set based on the actual application requirements, and this embodiment does not specifically limit it.

Specifically, when the first power switch is conducting, briefly interrupt the first power switch to stop supplying power to the load, monitor the voltage at the power output terminal during the time the first power switch is interrupted. If the load is still connected to the power output terminal, the voltage at the power output terminal will decrease due to the discharge through the load, and the greater the current flowing through the load, the faster the voltage drop at the power output terminal. Therefore, as long as the voltage at the power output terminal does not drop to the first preset voltage threshold within a certain period (such as the first preset duration), it can be determined that the current flowing into the load is small enough to indicate an open circuit in the load. The choice of the first preset duration can be based on a comprehensive consideration of determining the normal operating current of the output load, the threshold current for an open circuit, the leakage current at the power output terminal after the load is disconnected, and the total capacitance at the power output terminal. This ensures that the normal operating load current can pull down the voltage at the power output terminal to below the first preset voltage threshold within the first preset duration, without dropping low enough to affect the normal operation of the load. Moreover, relying solely on the leakage current at the power output terminal and the threshold current for an open circuit in the output load is not sufficient to lower the voltage at the power output terminal to the first preset voltage threshold within the first preset duration, thereby ensuring the accuracy of the open circuit determination for the load. In some embodiments, the first preset voltage threshold may be the same as the second preset voltage threshold to simplify the design of the first comparator U1.

The simplified circuit implementing the load open circuit detection method as shown in FIG. 9 is illustrated in FIG. 9A. In this configuration, the controller 10 can temporarily interrupt and then conduct the first power switch Q1, while the first comparator U1 is used to monitor the voltage at the power output terminal VOUT. It should be noted that, when adopting the load open circuit detection method illustrated in FIG. 9A, each time the first power switch Q1 is configured to conduct after a brief interruption, and it is turned on directly, without using a soft start method. This ensures that the output load can operate normally during the output open circuit detection process. When using the approach of briefly interrupting the first power switch Q1 as shown in FIG. 9 for load open circuit detection, the reset of the soft start circuit can be performed when determining an open circuit in the load and when turning off the first power switch Q1.

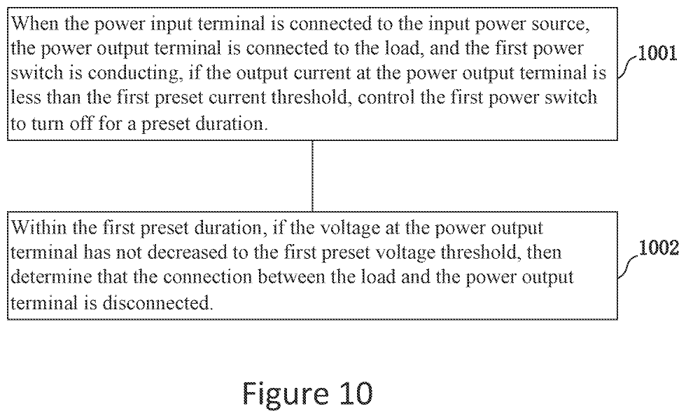

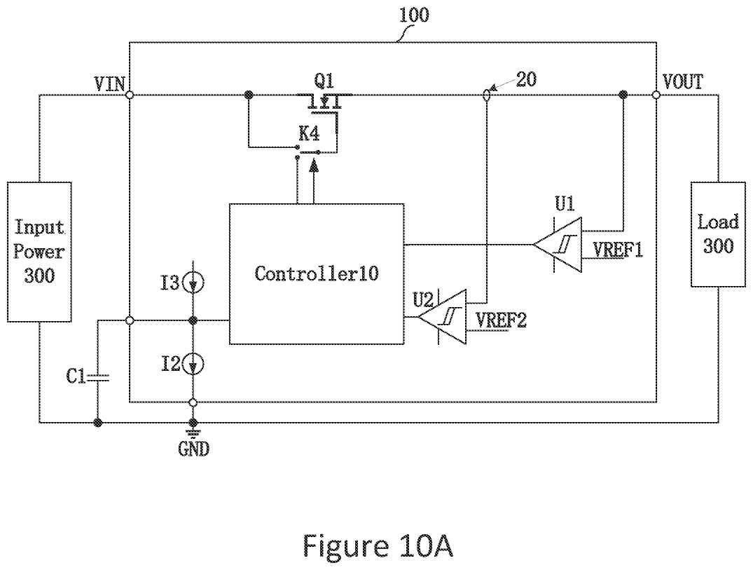

Please refer to FIG. 10, which illustrates a third method for determining the disconnection of the connection between the load and the power output terminal in the control method of the electronic fuse. As shown in FIG. 10, the control method of this electronic fuse includes the following method steps:
Step 1001: when the power input terminal is connected to the input power source, the power output terminal is connected to the load, and the first power switch is conducting, if the output current at the power output terminal is less than the first preset current threshold, control the first power switch to turn off for a preset duration.
Step 1002: within the first preset duration, if the voltage at the power output terminal has not decreased to the first preset voltage threshold, then determine that the connection between the load and the power output terminal is disconnected.

Specifically, the third method combines the first and second methods to enhance the accuracy of open-circuit detection and simultaneously achieve real-time detection of load disconnection.

It should be noted that in the control methods described in FIGS. 9 and 10, it is also possible to use a method where the first power switch Q1 is configured to be in a pre-turn-off state (or connect as a diode) for the first preset duration, i.e., short-circuiting the gate and drain of the first power switch Q1 to achieve the disconnection of the first power switch Q1. As shown in FIG. 10A, the electronic fuse 100 also includes a fourth switch K4. The fourth switch K4 is controlled by the controller 10, and the controller 10 can change the connection mode of the gate of the first power switch Q1 by controlling the fourth switch K4. When the controller 10 controls the first power switch Q1 to turn on, it can connect the gate of the first power switch Q1 to the controller 10, which provides a high voltage level higher than the power output terminal VOUT to turn on the first power switch Q1. However, when pre-turn-off the first power switch Q1 for the first preset duration, the fourth switch K4 can connect the gate of the first power switch Q1 to the drain, configuring it as a diode. The advantage of having this is that if there is a sudden transient load current during the period when the first power switch Q1 is pre-turn-off, the first power switch Q1 can turn on in the form of a diode to provide the transient large current needed to meet the load, preventing the load from losing power. Only when it is detected, within the first preset duration, that the voltage at the power output terminal VOUT has not decreased to the first preset voltage threshold, confirming the disconnection between the load 300 and the power output terminal VOUT, the fourth switch K4 is configured to connect the gate of the first power switch Q1 to the controller 10, and the controller 10 keeps the first power switch Q1 turned off.

Similarly, the operation of turning off the first power switch Q1 by short-circuiting the gate and drain can be applied to the circuit shown in FIG. 6, resulting in the circuit structure shown in FIG. 6A. This approach can also avoid the impact on stable power supply to the load caused by dynamic current demands during the change of the current detection circuit range.

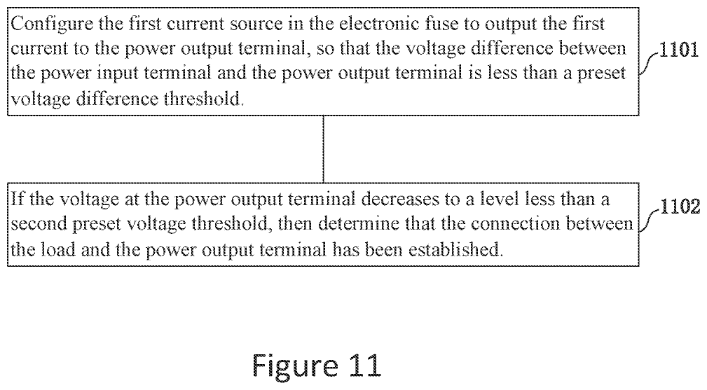

Please refer to FIG. 11. FIG. 11 exemplarily illustrates the first way to determine the establishment of the connection between the load and the power output terminal after controlling the first power switch to turn off. As shown in FIG. 11, the control method of this electronic fuse further comprises the following method steps:
Step 1101: configure the first current source in the electronic fuse to output the first current to the power output terminal, so that the voltage difference between the power input terminal and the power output terminal is less than a preset voltage difference threshold.
Step 1102: if the voltage at the power output terminal decreases to a level less than a second preset voltage threshold, then determine that the connection between the load and the power output terminal has been established.

After the first power switch is turned off, the insertion of the load is detected by monitoring the drop in voltage at the power output terminal. Specifically, after the first power switch is turned off, a current source (such as the first current source I1 shown in FIG. 2) is configured to output the first current to the power output terminal, keeping the voltage at the power output terminal close to the voltage at the power input terminal. Due to the limited current output capability of the first current source, when the load is inserted, the current required by the load cannot be satisfied by the current output from the first current source, causing a drop in voltage at the power output terminal. At this point, continuously monitoring the voltage at the power output terminal. When a voltage drop is detected at the power output terminal due to the insertion of the load, it is determined that the connection between the load and the power output terminal has been established.

Finally, it should be noted that the above embodiments are provided for the purpose of illustrating the technical solution of the present application and not for limiting it. Under the principles of the present application, the technical features in the above embodiments or different embodiments can be combined, the steps can be implemented in any order, and many other variations exist in different aspects of the present application as described above, which are not provided in detail for the sake of brevity. Although detailed descriptions have been given with reference to the above embodiments, those skilled in the art should understand that modifications can still be made to the technical solutions recorded in the above embodiments, or some technical features can be equivalently replaced. Such modifications or replacements do not depart from the essence of the technical solutions of the embodiments of the present application.

Although embodiments of the present disclosure and its advantages have been described in detail, it should be understood that various changes, substitutions and alterations can be made herein without departing from the spirit and scope of the disclosure as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A control method for controlling an electronic fuse comprising a first power switch having two non-control terminals, a first non-control terminal of the first power switch connected to a power input terminal and a second non-control terminal of the first power switch connected to a power output terminal, the method comprising:
when the power input terminal is connected to an input power source, the power output terminal is connected to a load, and the first power switch is conducting, if it is determined that a connection between the load and the power output terminal is disconnected, controlling the first power switch to turn off; and
after controlling the first power switch to turn off, if it is determined that the connection between the load and the power output terminal is established, controlling the first power switch to conduct in a soft start manner through a soft start circuit.

2. The method of claim 1, further comprising:
when the power input terminal is connected to the input power source, the power output terminal is connected to the load, and the first power switch is conducting, if an output current at the power output terminal is less than a first preset current threshold, determining that the connection between the load and the power output terminal is disconnected.

3. The method of claim 1, further comprising:
when the power input terminal is connected to the input power source, the power output terminal is connected to the load, and the first power switch is conducting, controlling the first power switch to turn off for a first preset duration, within the first preset duration, if a voltage at the power output terminal has not decreased to a first preset voltage threshold, determining that the connection between the load and the power output terminal is disconnected.

4. The method of claim 3, wherein the step of controlling the first power switch to turn off for the first preset duration includes:
configuring the first power switch in the form of a diode connection, such that the first power switch remains off when a voltage difference between the power input terminal and the power output terminal is less than a first voltage difference threshold; and
maintaining the first preset duration.

5. The method of claim 1, further comprising:
when the power input terminal is connected to the input power source, the power output terminal is connected to the load, and the first power switch is conducting, if an output current at the power output terminal is less than a first preset current threshold, controlling the first power switch to turn off for a first preset duration, within the first preset duration, if a voltage at the power output terminal has not decreased to the first preset voltage threshold, determining that the connection between the load and the power output terminal is disconnected.

6. The method of claim 5, wherein the step of controlling the first power switch to turn off for the first preset duration includes:
configuring the first power switch in the form of a diode connection, such that the first power switch remains off when a voltage difference between the power input terminal and the power output terminal is less than a first voltage difference threshold; and
maintaining the first preset duration.

7. The method of claim 1, wherein after controlling the first power switch to turn off, the method further comprises:
configuring a first current source in the electronic fuse to output a first current to the power output terminal, in order to maintain a voltage difference between the power input terminal and the power output terminal that is less than a preset voltage difference threshold; and
determining that the connection between the load and the power output terminal is established if the voltage at the power output terminal decreases to below a second preset voltage threshold.

8. The method of claim 1, further comprising:
resetting the soft start circuit in the electronic fuse when the first power switch is conducting, so that the first power switch is configured to conduct in a soft start manner at a next time, wherein after controlling the first power switch to turn off, the method further comprises:
resetting the soft start circuit in the electronic fuse when the first power switch is conducting, so that the first power switch is configured to conduct in a soft start manner at a next time.

9. An electronic fuse comprising:
a first power switch having two non-control terminals, a first non-control terminal of the first power switch connected to a power input terminal and a second non-control terminal of the first power switch connected to a power output terminal; and
a controller configured to execute a control method comprising:
when the power input terminal is connected to an input power source, the power output terminal is connected to a load, and the first power switch is conducting, if it is determined that a connection between the load and the power output terminal is disconnected, controlling the first power switch to turn off; and
after controlling the first power switch to turn off, if it is determined that the connection between the load and the power output terminal is established, controlling the first power switch to conduct in a soft start manner through a soft start circuit.

10. The electronic fuse of claim 9, wherein the electronic fuse further comprises a first comparator, and wherein:
the first comparator is connected to both the power output terminal and the controller; and
the first comparator is used to output a first comparison signal to the controller based on a comparison result between a voltage at the power output terminal and a preset reference voltage threshold, and wherein the first comparison signal is at a first logic level when the voltage at the power output terminal is greater than the reference voltage threshold, and the first comparison signal is at a second logic level when the voltage at the power output terminal is less than or equal to the reference voltage threshold.

11. The electronic fuse of claim 10, wherein the electronic fuse further comprises a second comparator, and wherein:
the second comparator is used to output a second comparison signal based on a comparison result between an output current at the power output terminal and a first preset current threshold, and wherein, the second comparison signal is at a first logic level when the output current is less than the first preset current threshold, and the second comparison signal is at a second logic level when the output current is greater than or equal to the first preset current threshold;
the controller is also connected to the second comparator and is used to receive both the first comparison signal and the second comparison signal; and
the controller is configured to control the first power switch to turn off when both the first comparison signal and the second comparison signal are at the first logic level.

12. The electronic fuse of claim 11, wherein:
a first input terminal of the first comparator is connected to the power output terminal;
a second input terminal of the first comparator receives the reference voltage threshold;
an output terminal of the first comparator is connected to the controller;
a first input terminal of the second comparator receives a voltage signal or a current signal corresponding to the output current at the power output terminal;
a second input terminal of the second comparator receives a voltage signal or a current signal corresponding to the first preset current threshold; and
an output terminal of the second comparator is connected to the controller.

13. The electronic fuse of claim 9, wherein the electronic fuse further comprises a first current source, and wherein:
the first current source is connected to the power output terminal and is configured to output a current to the power output terminal after the first power switch is turned off.

14. The electronic fuse of claim 13, wherein the first current source comprises a first resistor and a first switch, and wherein:
a circuit formed by a series connection of the first resistor and the first switch is parallel to the first power switch; and
the first switch is configured to turn on after the first power switch is turned off.

15. The electronic fuse of claim 13, wherein the first current source comprises a second power switch and a second switch, and wherein:
the second power switch is parallel to the first power switch, and the second switch is connected between a control terminal of the second power switch and a control terminal of the first power switch; and
the second switch is configured to turn off when both the first comparison signal and the second comparison signal are at the first logic level, allowing the second power switch to be individually controlled and maintained by the controller in a conducting state when the first power switch is turned off.

16. The electronic fuse of claim 9, wherein the soft start circuit includes a second current source and a third current source, and wherein:
both the second current source and the third current source are connected to the controller;
both the second current source and the third current source are connected to an external first capacitor;
the second current source is configured to discharge the first capacitor when the soft start circuit is reset;
the third current source is configured to, after the soft start circuit is reset, during the process of re-conducting the first power switch, charge the first capacitor, enabling the first power switch to conduct in a soft start manner.

17. The electronic fuse of claim 9, further comprising a second comparator, a third switch, a second resistor, a third resistor, a first operational amplifier, a third power switch, and a fourth power switch, wherein:
a first terminal of the third switch is connected to a first terminal of the first power switch;
a second terminal of the third switch is connected to a first terminal of the third power switch;
a first terminal of the second resistor and a first terminal of the third resistor are both connected to the power input terminal;
a second terminal of the second resistor is connected to both a first input terminal of the first operational amplifier and a third terminal of the third power switch;
a second terminal of the third resistor is connected to both a second input terminal of the first operational amplifier and a second terminal of the fourth power switch;
an output terminal of the first operational amplifier is connected to a first terminal of the fourth power switch;
a third terminal of the fourth power switch is connected to one input terminal of the second comparator;
an output terminal of the second comparator is connected to the controller;
the controller is further configured to control the third switch to establish a connection between a gate of the first power switch and a gate of the third power switch when a detected current flowing through the fourth power switch is greater than or equal to a second preset current threshold;
the controller is configured to control the third switch to disconnect a connection between the gate of the first power switch and the gate of the third power switch, and configure the first power switch to function as a diode when a detected current is less than a second preset current threshold; and
the controller is configured to turn off the first power switch when the output current is less than the first preset current threshold.

18. The electronic fuse of claim 17, wherein when the first power switch is conducting, the controller configures the first power switch to function as a diode for a first preset duration, and wherein within the first preset duration, if a voltage at the power output terminal has not decreased to a first preset voltage threshold, the controller controls the first power switch to turn off.

19. The electronic fuse of claim 17, further comprising a second comparator, wherein:
the second comparator is used to output a second comparison signal based on a comparison result between an output current at the power output terminal and a first preset current threshold, and wherein:
when the first power switch is conducting, if the output current at the power output terminal is less than the first preset current threshold, the controller configures the first power switch to function as a diode for the first preset duration; and
within the first preset duration, if a voltage at the power output terminal has not decreased to the first preset voltage threshold, the controller determines that the connection between the load and the power output terminal is disconnected.

20. The electronic fuse of claim 17, further comprising a pre-turn-off switch, wherein:
the pre-turn-off switch is connected between a gate and a drain of the first power switch, and the pre-turn-off switch is connected to the controller;
the controller is further configured to control the pre-turn-off switch to establish a connection between the gate and the drain of the first power switch, thereby controlling the first power switch to function as a diode.

21. The electronic fuse of claim 9, wherein:
when the first power switch is turned off and the voltage at the power output terminal decreases to less than or equal to a second preset voltage threshold, the controller controls the first power switch to be turned on in a soft start manner.
